(19) United States
(12) Patent Application Publication
(10) Pub. No.: US 2004/0214151 A1
(43) Pub. Date: Oct. 28, 2004

(54) Automatic and interactive computer teaching system

(75) Inventors: Kuo-Ping Yang, Taipei (TW); Ching-Hsiang Shih, Taipei (TW)

Correspondence Address: BACON & THOMAS, PLLC, 625 SLATERS LANE, FOURTH FLOOR, ALEXANDRIA, VA, 22314

(73) Assignee: Kuo-Ping Yang, Taipei (TW)

(21) Appl. No.: 10/677,226

(22) Filed: Oct. 3, 2003

(30) Foreign Application Priority Data
Apr. 23, 2003 (TW) 092109509

(51) Int. Cl. G09B 3/00

(52) U.S. Cl. 434/323

(57) ABSTRACT

A main computer with multiple operating devices enables multiple users to manipulate the main computer. The main computer has interactive teaching software and multiple teaching slides, so that the interactive teaching software is executed to achieve the following:

displaying one teaching slide, wherein the teaching slide has multiple buttons;

allowing at least one operating device to manipulate the process of displaying teaching slides so that the operating device can choose buttons from the displayed teaching slide, wherein the manner of allowing at least one operating device to manipulate the process of displaying teaching slides includes choosing one operating device from multiple operating devices;

accepting a choice made by an operating device; and

displaying another teaching slide after the choice has been made.

### BACKGROUND OF THE INVENTION

1. Field of the Invention

The present invention relates to an automatic and interactive computer teaching system and, more particularly, to a system that may be used in a school environment.

2. Description of the Related Art

Because of the increasing popularity of computers, the development of computer aided teaching is becoming more and more important. In many teaching environments, a teacher will operate a computer to instruct a plurality of students. But in some classrooms, every student or every pair of students, use a single computer to practice amongst themselves.

In the prior art method, the teacher has primary control of the interactive teaching software.

Research indicates, however, that there are some advantages in providing program control to individual students. However, there is no solution for providing such control to a plurality of students.

Additionally, if the teacher wishes to call upon a student to answer a question, the teacher can do so orally, and the assigned student can respond orally. But if the question requires some operating of the computer, the student will have to leave off answering the teacher's question.

### SUMMARY OF THE INVENTION

The main objective of the present invention is to provide an interactive computer teaching system that can be operated by students.

Another objective of the present invention is to provide a means that can allow many different operating methods, such as assigning a student to manipulate a teaching slide by way of an operating device, or enabling all students to manipulate the teaching slide by way of all of the operating devices, or letting a student to assign another student to manipulate the teaching slide by way of an operating device.

Another objective of the present invention is to provide variation in the teaching style of a teacher, since the students can directly take part in the teaching process.

In order to achieve the above-mentioned objectives, the present invention comprises a host computer comprising a processor and a memory, wherein the memory stores an interactive program executable by the processor. The interactive program accepts a plurality of different operational instructions and comprises a plurality of teaching pictures; a plurality of operational devices for use by the plurality of students and outputting operational instructions to the teaching computer to use the interactive learning system, wherein each operational device has a unique ID code, and each operational instruction is output with one ID code so that the teaching computer is capable of identifying each operational device.

The host computer has a first means for displaying one teaching slide, wherein the teaching slide has a plurality of buttons; a second means for allowing at least one operating device to manipulate a process of displaying teaching slides so that the operating device can choose buttons from the displayed teaching slide, wherein a control manner of allowing at least one operating device to manipulate the process of displaying teaching slides includes choosing one operating device from multiple operating devices. The host computer further comprises a third means for accepting a selection made by the operating device, and a fourth means for displaying another teaching slide after the third means has completed operation.

Other objectives, advantages, and novel features of the invention will become more apparent from the following detailed description when taken in conjunction with the accompanying drawings.

### BRIEF DESCRIPTION OF THE DRAWINGS

FIG. 1 is a structure drawing of an automatic and interactive computer teaching system according to the present invention.

FIG. 2 shows an operating device according to the present invention.

FIG. 3 is a circuit block drawing of the operating device according to the present invention.

FIG. 4 is a circuit block drawing of a portable computer according to the present invention.

FIG. 5 is a circuit block drawing of a connection device according to the present invention.

FIG. 6 is a primary flowchart of an interactive teaching program according to the present invention.

FIG. 7 schematic drawing showing the relationship between a plurality of instruction slides and a plurality of question slides according to the present invention.

FIG. 8 is an embodiment of an instruction slide according to the present invention.

FIG. 9 is an embodiment of a question slide according to the present invention.

FIG. 10 is a first embodiment flowchart of processing an instruction slide according to the present invention.

FIG. 11 is a second embodiment flowchart of processing an instruction slide according to the present invention.

FIG. 12 is a first embodiment flowchart of processing a question slide according to the present invention.

FIG. 13 is a second embodiment flowchart of processing a question slide according to the present invention.

FIG. 14 is a program schematic drawing of the instruction slide according to the present invention.

FIG. 15 is a program schematic drawing of a question slide according to the present invention.

FIG. 16 is a flowchart of changing an operating device's assignment according to the present invention.

FIG. 17 is an embodiment of changing an operating device's assignment according to the present invention.

### DETAILED DESCRIPTION OF THE PREFERRED EMBODIMENT

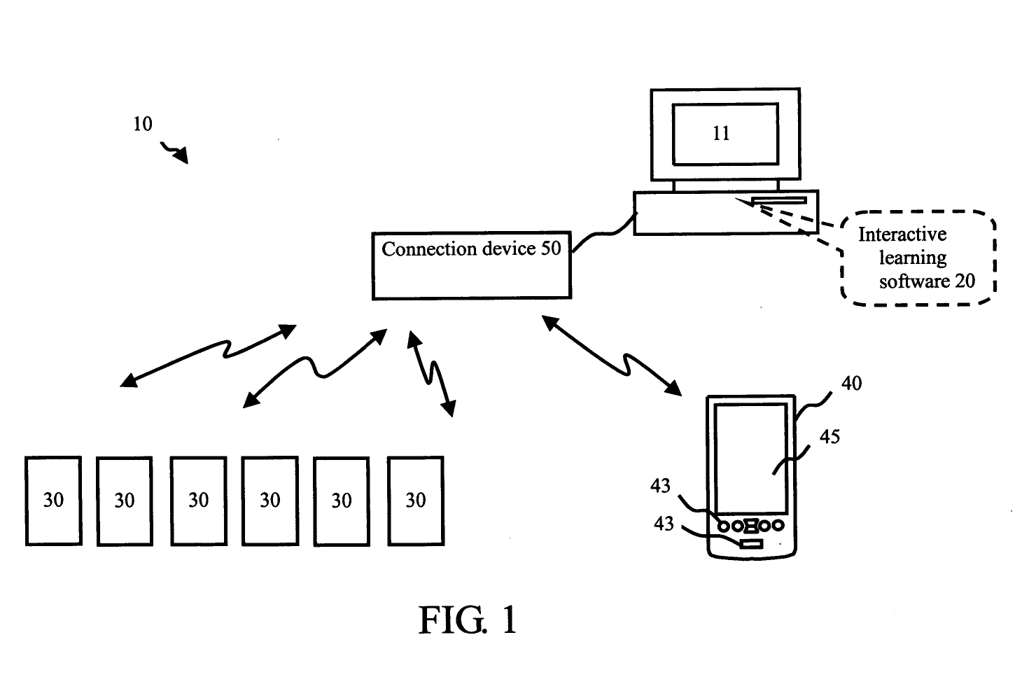

Please refer to FIG. 1. FIG. 1 is a structure drawing of an automatic and interactive computer teaching system according to the present invention. The automatic and interactive computer teaching system 10 can be applied in a computer environment supporting a teacher with a plurality of students.

A teaching computer 11 can be a typical computer. The teaching computer 11 is used to execute at least one interactive learning program 20. The interactive learning program 20 is simple quiz learning software, or complex quiz learning software. The teaching computer 11 outputs pictures for the teacher and the plurality of students. The output pictures can also be sent to a projector.

Each student uses an operational device 30 to serve as an input tool for the teaching computer 11, which output a plurality of operational instructions to the teaching computer 11 to control the interactive learning program 20. It is a preferred method that every student has one operational device 30, but it is also acceptable if several students share one operational device 30.

The teacher operates a portable computer 40 to control the teaching computer 11, and the portable computer 40 can be a personal digital assistant (PDA). In the prior art system, the teacher operates the teaching computer 11 directly, but in the present invention, the teacher can move around with the portable computer 40 and use the portable computer 40 to control the teaching computer 11.

There is a connection device 50 in this embodiment. The connection device 50 is connected to the operational device 30 and the teaching computer 11 via cables, so that the operational instruction output by the operational device 30 can be received by the teaching computer 11. Furthermore, signals from the portable computer 40 are sent to the connection device 50 and then to the teaching computer 11. In this embodiment, the portable computer 40 is wirelessly connected to the connection device 50. It should be clear that any apparatus in the interactive computer teaching system 10 can be connected with cables, or in a wireless manner. An additional item that should be noted is that if the host computer is an advanced model or supports a suitable design, the connection device 50 may be not necessary. For example, if the teaching computer 11 supports wireless communications, the portable computer 40 can communicate with the teaching computer 11 directly.

The following description relates to the hardware structure of the teaching computer 11, the operational device 30, the portable computer 40 and the connection device 50.

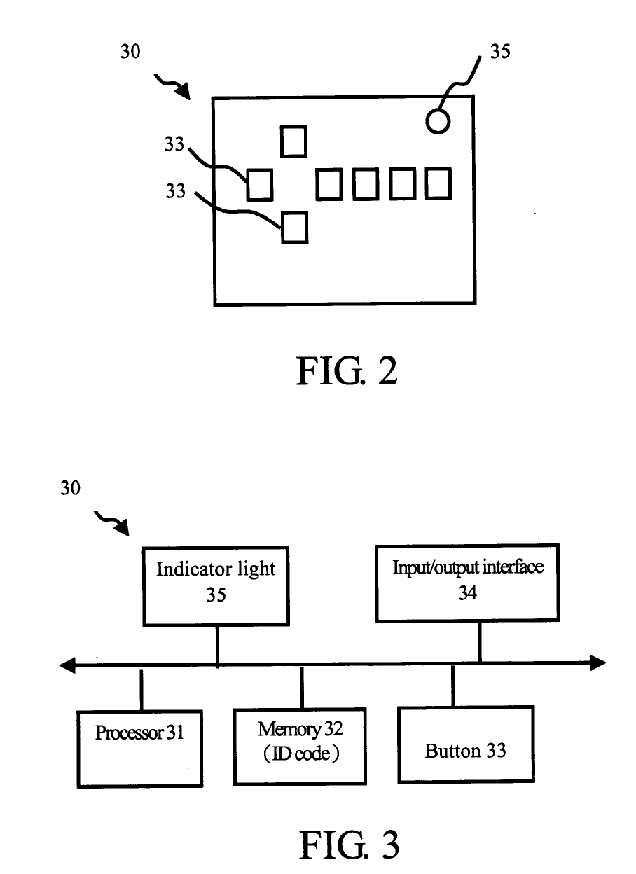

FIG. 2 is an appearance drawing of an operating device according to the present invention. The operational device 30 can be box shaped with a plurality of buttons 33. The plurality of buttons 33 may be up, down, left and right buttons. The operational device 30 may have an indicator light 35 that turns on when the operational device 30 is turned on to provide a reminder to the students, which can be also installed in each button 33. Moreover, the operational device 30 can also have a touch screen (similar to a PDA), and in this case the plurality of buttons 33 may be visual buttons on the screen.

FIG. 3 is a circuit block drawing of the operational device according to the present invention. The operational device 30 comprises a processor 31, a memory 32, the plurality of buttons 33 and an input/output interface 34 connected to the connection device 50. In this embodiment, the operational device 30 is connected to the connection device wirelessly, so the input/output interface 34 requires wireless transmission functionality. Each operational device 30 has a unique ID code, and the operational instruction is output with one ID code so that the teaching computer 11 can identify the corresponding operational device 30.

The operational device 30 may be a common electronic device, such as an external keyboard, but this is not the primary issue of the present invention, and so is not elaborated upon.

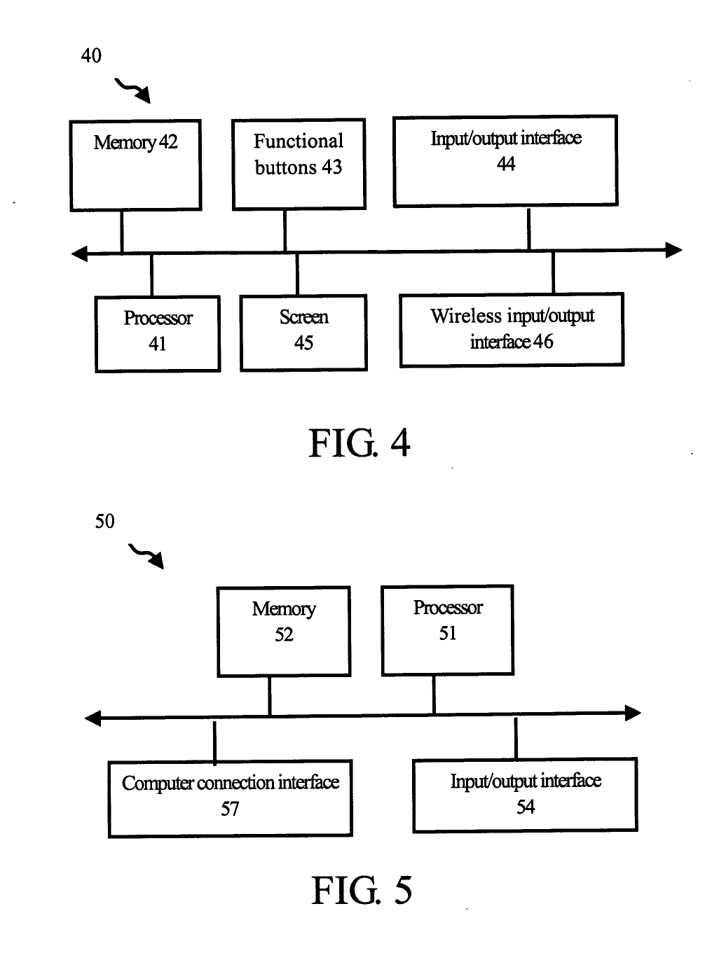

FIG. 4 is a diagram of a portable computer 40 according to the present invention. The portable computer 40 comprises a processor 41, a memory 42, a plurality of function buttons 43, an input/output interface 44, a screen 45 and a wireless input/output device 46. The portable computer 40 is similar to a standard computer. In the embodiment, the portable computer 40 uses the wireless input/output device 46 (such as an infrared port or a radio frequency port) to wirelessly transmit data to the connection device 50.

FIG. 5 is a diagram of a connection device 50 according to the present invention. The connection device 50 comprises a processor 51, a memory 52, a wireless input/output device 56, a computer link interface 57 and an operational device link interface 58. The wireless input/output device 56 corresponds to the wireless input/output device 46 of the portable computer 40 so that data may be transmitted between the two wirelessly. The computer link interface 57 is used for connecting to the teaching computer 11. The operational device link interface 58 is used for connecting to the plurality of operational devices 30. A primary function of the connection device 50 is to transmit signals between the teaching computer 11, the operational device 30 and the portable computer 40. The connection device 50 is a simple device, is not the primary issue of the present invention, and so will not be elaborated upon.

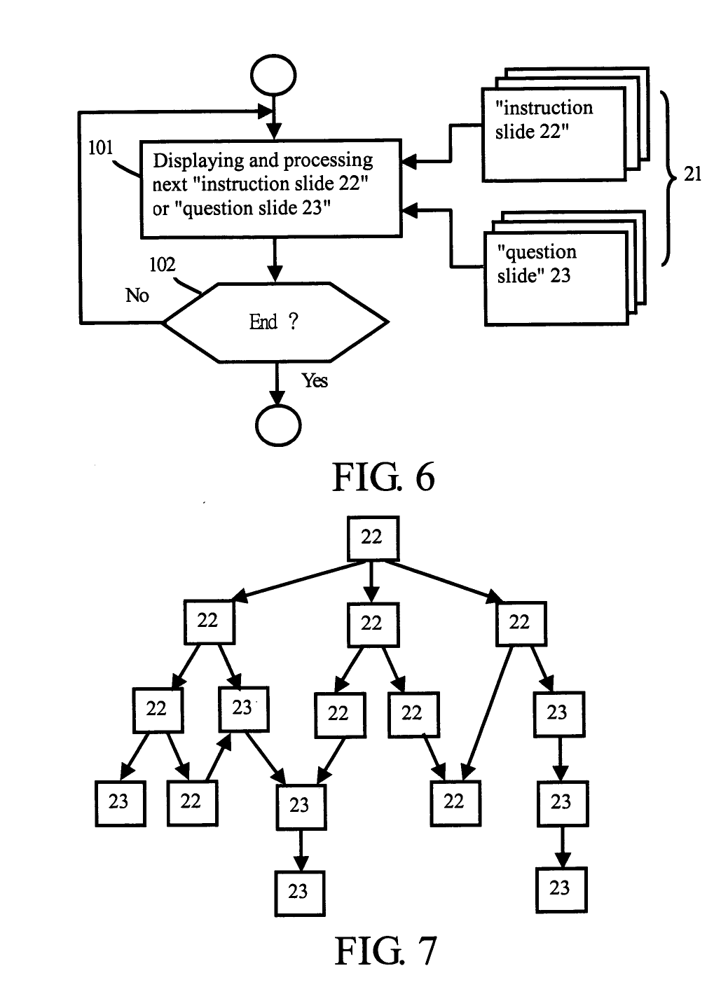

FIG. 6 is a primary flowchart of an interactive teaching program according to the present invention. This flowchart is similar to other teaching software, and which has the following steps: displaying and processing a “teaching slide 21” (step 101), the “teaching slide 21” can be an “instruction slide 22” or a “question slide 23” (sometimes the “teaching slide 21 is a combination of both the “instruction slide 22” and the “question slide 23”). In this invention, the “instruction slide 22” is used to display teaching information (text or figures) and the “question slide 23” is used to display a question. The sequencing and relationships between each “instruction slide 22” and each “question slide 23” is predetermined, such as shown in a relationship diagram depicted in FIG. 7. FIG. 7 is a schematic drawing showing the relationship between a plurality of instruction slides and a plurality of question slides according to the present invention. In step 102, it is determined if displaying of the “instruction slide 22” and the “question slide 23” should be stopped. There are seveal different ways to end the teaching process. For example, the teacher can end the session, or if there are no more slides to display.

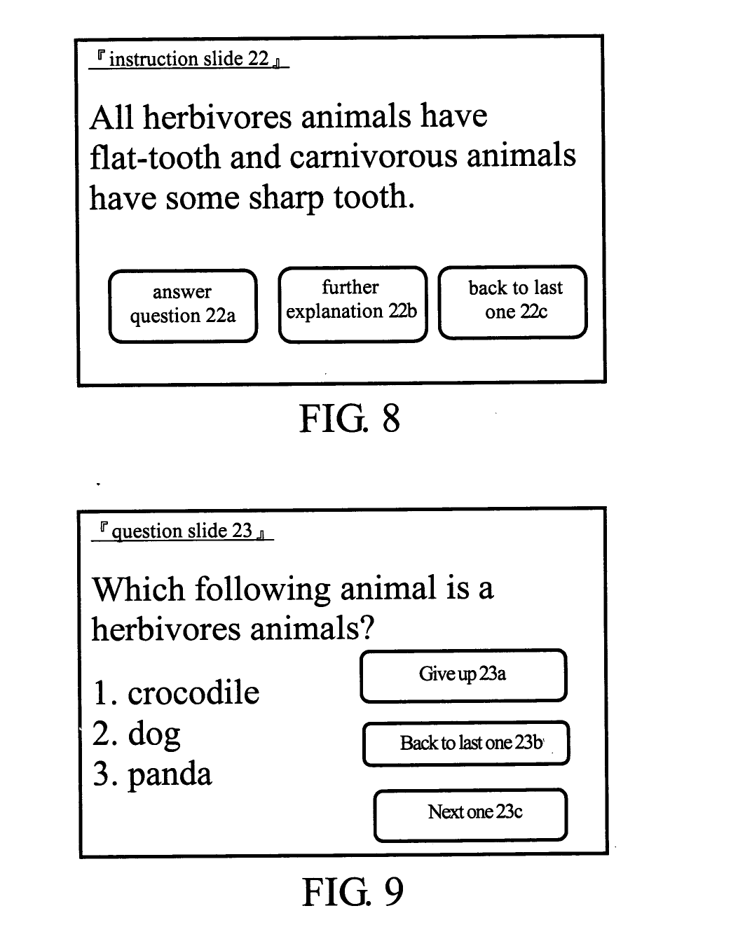

FIG. 8 is an embodiment of an instruction slide according to the present invention. Buttons are provided on the “instruction slide 22”, which permit actions such as clicking on an “answer question” button 22a to connect to the “question slide 23” (shown in FIG. 9); or clicking on a “further explanation” button 22b to connect to another “instruction slide 22”; clicking on a “last one” 22c to connect to a last “instruction slide 22” or a “question slide 23”. As a consequence, the “instruction slide 22” in the present invention provides an interactive teaching environment.

A feature of the present invention is that the plurality of buttons on the “instruction slide 22” can be clicked by the students instead of being controlled by the teacher.

The interactive learning program 20 can proceed to steps 201-203 (sub-steps of the step 101) or into steps 301-304 (sub-steps of the step 101).

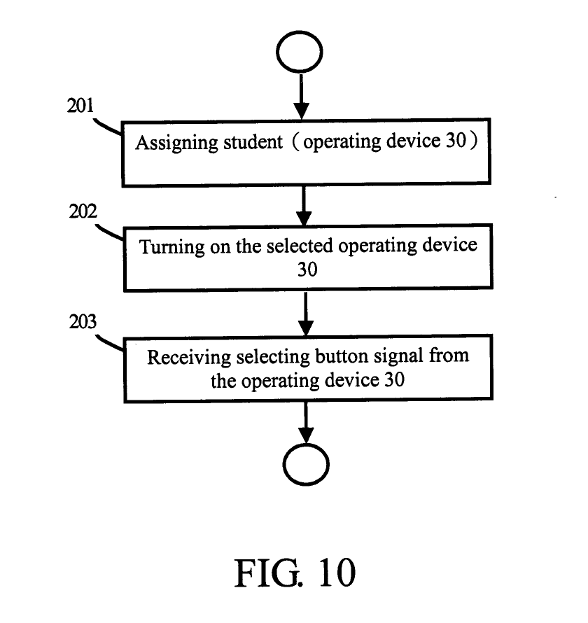

Steps 201-203 are explained in the following, as shown in FIG. 10:

Step 201:

The interactive learning program 20 selects at least one student (operating device 30). This can be done by a random selection or according to a student score record. Furthermore, the teacher can select a student via the portable computer 40, and may input related information (such as an ID number of the student, a seat number or an ID number for the operational device 30) of that student into the teaching computer 11.

Step 202:

The selected operating device 30 (operated by the selected student) is turned on and the selected student can select the button 22a, 22b or 22c via the operating device 30. Whether the operating device is turned on or off is controlled by the teaching computer 11 via the connection device 50, which is an active selection manner. Another selection manner is not to control the operating device 30, but instead every operating device 30 sends a signal and the teaching computer 11 or the connection device 50 rejects unnecessary or unwanted signals. For example, operating devices No. 001˜010 30 all send signals, but the selected student operates No. 003 operating device 30, so the interactive learning program 20 will only receive the signal from the No. 003 operating device 30, which is a passive selection manner.

Step 203:

The students select buttons on the slide, which are the button 22a, the button 22b or button 22c, to decide the next step.

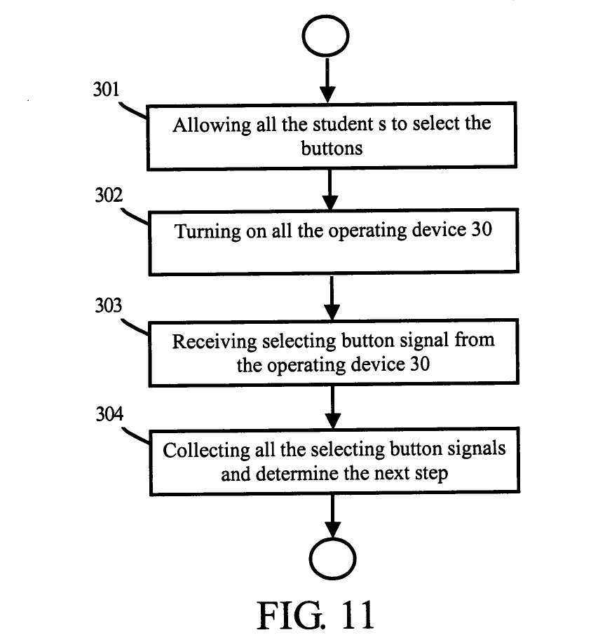

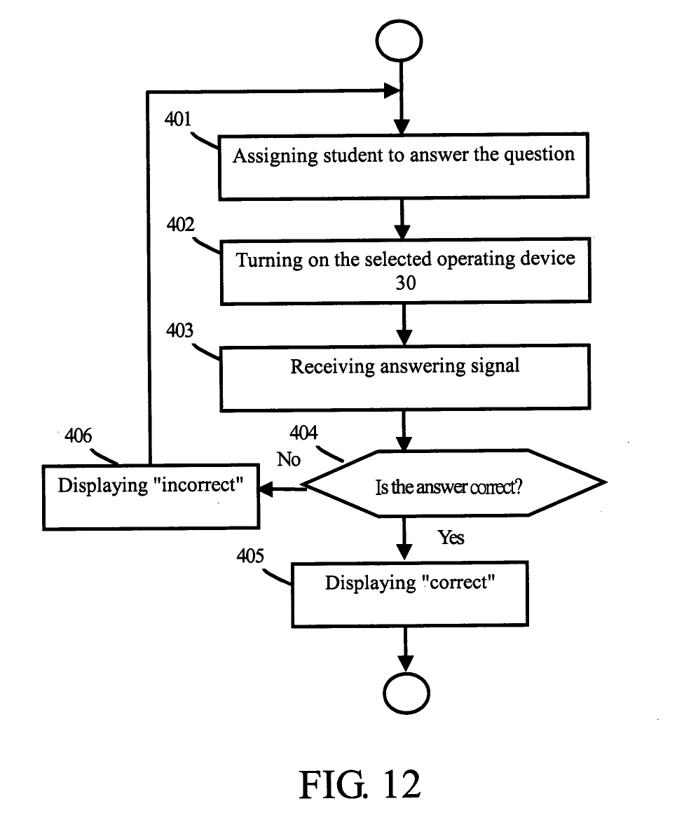

Following description explains steps 301˜304, as shown in FIG. 11:

Step 301:

The interactive learning program 20 allows all students to select the buttons on the slide.

Step 302:

Since all the students can select the buttons on the slide, all the operating devices 30 are turned on. Similar to step 202, if a passive selection manner is taken, the teaching computer 11 and the connection device 50 will receive all signals from all of the operating devices.

Step 303: The interactive learning program 20 receives a signal corresponding to a selecting button from the operating device.

Step 304: collect all the selecting button signals and determine the next step. For example, if most of the students select the button 21a, the question slide 23 is displayed next.

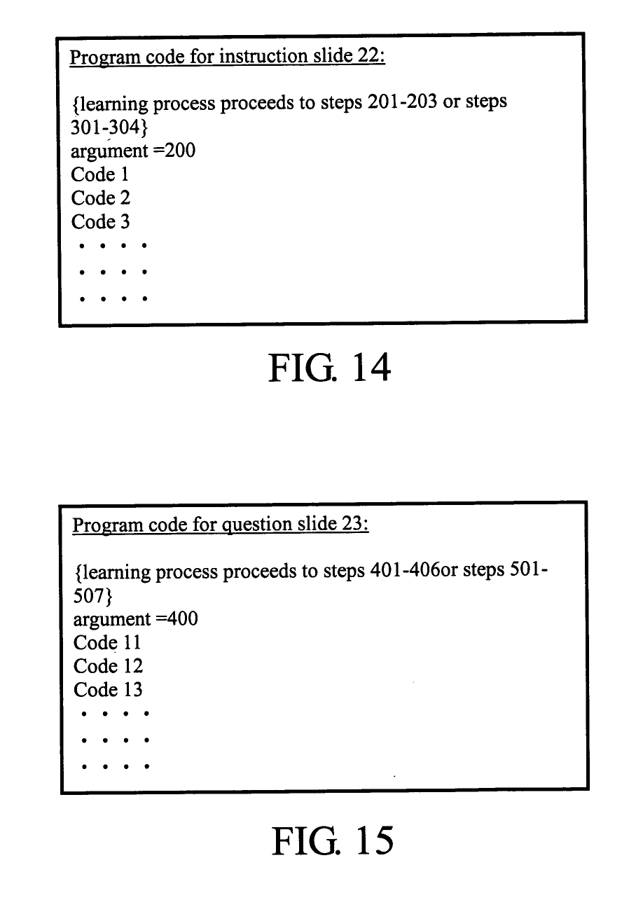

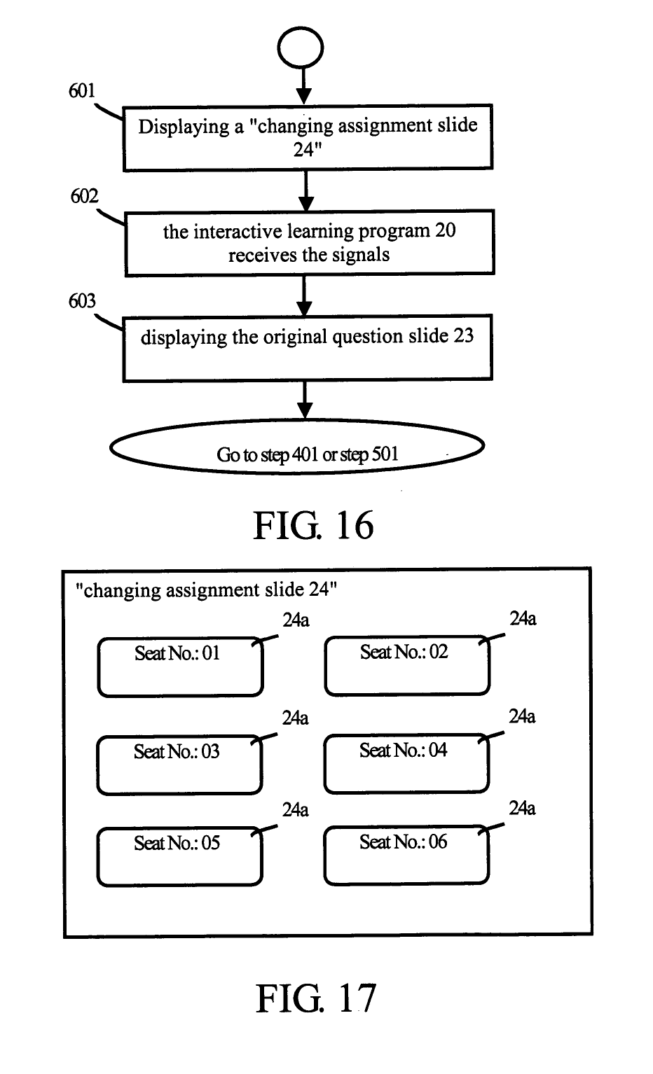

Another characteristic of the present invention is that the interactive learning program 20 may enter into steps 201-203, or the steps 301-304. The operating procedure of the interactive learning program can be predetermined. Please refer to FIG. 14. FIG. 14 is a program schematic drawing of an instruction slide according to the present invention. Program code of the instruction slide 22 has an argument, for example such as 200 that means the next section is to process steps 201-203; if the argument is 300, then the next section is to process the steps 301-304. Alternatively, the teacher can use the portable computer 40 to assign the student to change the argument, and so the student can decide if the interactive learning program proceeds to steps 201-203 or the steps 301-304.

FIG. 9 is an embodiment of a question slide according to the present invention. Buttons are provided in the “question slide 23”. For example, clicking on a “give up” button 23a indicates a desire to quit; clicking on a “back to last one” button 23b indicates going to a last “instruction slide 22” or a last “question slide 23”; clicking on a “go to next one” indicates going to another “question slide 23”.

In a similar vein, another feature of the present invention is that the plurality of buttons on the “instruction slide 22” can be clicked by the students instead of being controlled by the teacher.

The interactive learning program 20 can proceed to steps 401-406 (sub-steps of the step 101) or to steps 501-507 (sub-steps of the step 101).

The following description explains steps 401-406. Please refer to FIG. 11.

Step 401: similar to step 201, please refer to step 201 for explanation.

Step 402: similar to step 202, please refer to step 202 for explanation.

Step 403: receiving a signal from a selected button, such as button 23a, button 23b or button 23c.

Step 404: determining if the answer is right. If it is correct, go to step 405. If it is wrong, go to step 406.

Step 405: displaying “correct”.

Step 406: displaying “incorrect”.

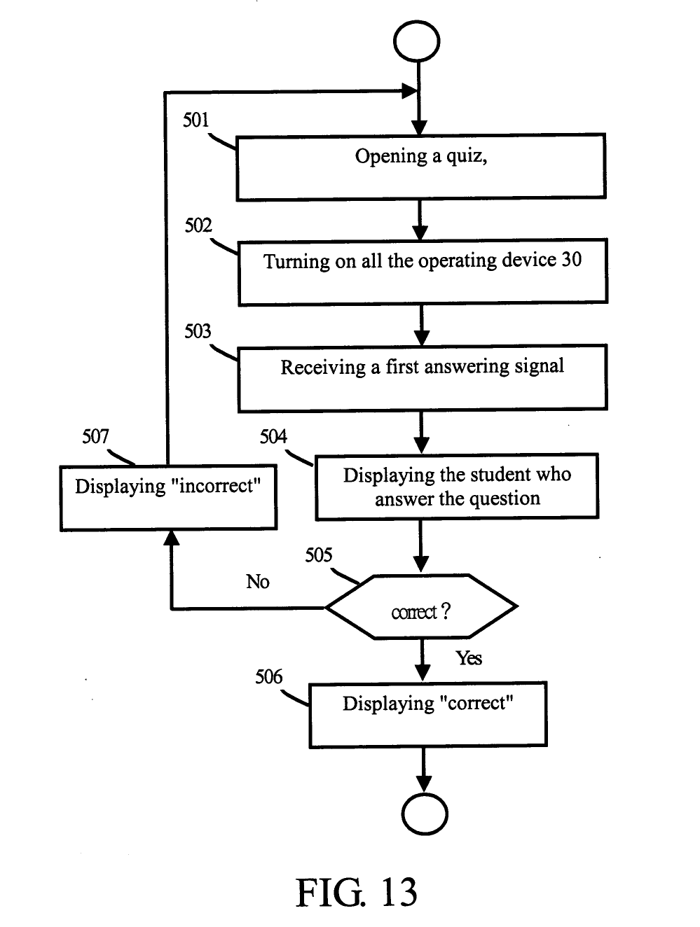

The following description explains steps 501-507. Please refer to FIG. 13:

Step 501: opening a quiz, which means that all of the students can join the quiz.

Step 502: turning on all operating devices 30, since all of the students can join the quiz, which is similar to step 302.

Step 503: receiving a first answer. The interactive learning program 20 can ignore the other answers or collect all student answers for recording purposes.

Step 504: displaying the student who first answered the quiz, such as No. 003 operating device 30.

Step 505 to step 507: similar to the steps 404-406.

Similarly, the learning program 20 may enter into the steps 401-406 or the steps 501-507. The execution procedure of the interactive learning program 20 can be predetermined. Please refer to FIG. 15. FIG. 15 is a program schematic drawing of the question slide 23 according to the present invention. Program code of the question slide 23 also supports an argument. For example, a 400 may indicate that the next section should process the steps 401-406; if the argument is a 500, then the next section is to process the steps 501-507. Alternatively, the teacher can use the portable computer 40 to assign a student to change the argument, and in this manner the student can cause the interactive learning program to proceed to steps 401-406 or steps 501-507.

Another characteristic of the present invention is to allow a student to assign another student to answer the question. For example, in step 403, if the student clicks on the “give up” button 23a on the question slide 23, then the interactive learning program 20 enters into steps 601-603.

Step 601: displaying a “changing assignment slide 24”. As shown in FIG. 17, the changing assignment slide 24 displays a plurality of buttons 24a that correlate to every student's seat number (or ID number, or the name of the student). Each button 24a corresponds to one operating device 30. For example, the student who clicked on the “give up” button 23a may select the student with a seat number No. 04.

Step 602: the interactive learning program 20 receives the signals and turns on the selected operating device 30, which is being operated by the student with the seat number No. 04.

Step 603: displaying the original question slide 23 shown in FIG. 9 again. After step 603, the interactive learning program 20 proceeds to step 401 or step 501.

Step 601-step 603 illustrate that the interactive learning program 20 enables a student to learn something about teaching and to have a main role in the teaching process, which is very different from the prior art technology.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed. For example, the present invention can be applied in multiple classes through the network, so students in different classes can operate the same interactive learning program 20. Then the host computers of different classes and the server connecting host computers can be treated as the host computer described in the above embodiment.

What is claimed is:

1. An automatic and interactive computer teaching system, the system comprising:
a host computer comprising a processor and a memory, wherein the memory stores an interactive program executable by the processor, the interactive program accepting a plurality of different operational instructions and comprising a plurality of teaching slides; and
a plurality of operational devices for use by the plurality of students and outputting an operational instruction to the teaching computer to use the interactive learning system, wherein each operational device has a unique ID code, and the operational instruction is output with one ID code so that the teaching computer is capable of identifying each operational device;
the host computer comprising:
a first means for displaying at least one teaching slide, wherein the teaching slide has a plurality of buttons;
a second means for allowing at least one operating device to manipulate a process of displaying teaching slides so that the operating device can choose buttons from the displayed teaching slide, wherein a control manner of allowing at least one operating device to manipulate the process of displaying teaching slides includes choosing one operating device from multiple operating devices;
a third means for accepting the choice made by the operating device; and
a fourth means for displaying another teaching slide after operation of the third means.

2. The automatic and interactive computer teaching system as claimed in claim 1, wherein the system further comprises a connection device, and an operating signal output by the plurality of operating devices is sent to the connection device and then to the host computer.

3. The automatic and interactive computer teaching system as claimed in claim 2, wherein a wireless communication device is applied between the connection device and the operating device.

4. The automatic and interactive computer teaching system as claimed in claim 1, wherein a button that is used for choosing one operating device for assignment to manipulate the process of displaying teaching slides activates the chosen operating device.

5. The automatic and interactive computer teaching system as claimed in claim 1, wherein at least one teaching slide has a plurality of arguments indicating how to cause the operating device to control the process of displaying teaching slides so that there is more than one control manner.

6. The automatic and interactive computer teaching system as claimed in claim 1, wherein the teaching slides include instruction slides and question slides, the teaching slides being used to display teaching information and the question slides being used to display questions to test a student's comprehension.

7. The automatic and interactive computer teaching system as claimed in claim 1, wherein the teaching slide shown by the first means is a changing assignment slide, the changing assignment slide including a plurality of buttons, and each button is associated with one operating device.

8. A computer readable memory media with an interactive computer teaching system software program, the interactive computer teaching system software being able to support a plurality of students, the plurality of students using operating devices to output operational instructions to operate the interactive computer teaching system software, wherein each operating device has a unique ID code, and an operational instruction is output with one ID code, the interactive computer teaching system software including the following program code:
a plurality of teaching slides;
a first program code for displaying one teaching slide, wherein the teaching slide has a plurality of buttons;
a second program code for allowing at least one operating device to manipulate a process of displaying teaching slides so that the operating device chooses buttons from the displayed teaching slide, wherein a control manner of allowing at least one operating device to manipulate the process of displaying teaching slides includes choosing one operating device from multiple operating devices;
a third program code for accepting a choice made by an operating device; and
a fourth program code for displaying another teaching slide after operation of the third means.

9. The computer readable memory media as claimed in claim 8, wherein at least one teaching slide has a plurality of arguments indicating how to cause the operating device to control the process of displaying teaching slides so that there is more than one control manner.

10. The computer readable memory media as claimed in claim 8, wherein the teaching slides include instruction slides and question slides, the teaching slides being used to display teaching inforamtion and the question slides being used to display questions to test a student's comprehension.
